(19) United States
(12) Patent Application Publication
(10) Pub. No.: US 2015/0034467 A1
(43) Pub. Date: Feb. 5, 2015

(54) KEYCAP MODULE FABRICATED BY INTEGRATED INJECTION

(71) Applicant: ZIPPY TECHNOLOGY CORP., New Taipei City (TW)

(72) Inventor: Chin-Hsiu HWA, New Taipei City (TW)

(73) Assignee: ZIPPY TECHNOLOGY CORP., New Taipei City (TW)

(21) Appl. No.: 13/956,066

(22) Filed: Jul. 31, 2013

(51) Int. Cl. H01H 13/7065

(52) U.S. Cl. CPC H01H 13/7065
USPC 200/5 A

(57) ABSTRACT

A keycap module fabricated by integrated injection includes a support frame which has a plurality of interlaced rims to define a plurality of keycap installation apertures. Each keycap installation aperture holds a keycap which has four sides and four corners. Each side of the keycap and each rim of the support frame have respectively a first wall and a second wall bridged by a movable arm. The keycaps, movable arms and support frame are integrally formed by injection. Each movable arm has a fist connecting section connected to one corner of the keycap and a second connecting section connected to the first connecting section at a first bend spot. The second connecting section is extended towards a neighboring corner of the keycap and connected to one rim of the support frame.

### FIELD OF THE INVENTION

The present invention relates to a keyboard press structure and particularly to a keycap module fabricated by integrated injection.

### BACKGROUND OF THE INVENTION

There are numerous types of input devices for computer systems, such as optical disk drivers, mouse, keyboards and the like. Among them keyboards are the most important. Conventional keyboards, such as those disclosed in TW patent Nos. 445471, 1220213 and M346861 generally have a keycap, a circuit board triggered by the keycap to generate a command Signal, a baseboard located at one side of the circuit board and a driven mechanism with two ends connecting to the keycap and baseboard. The keycap is moved towards the circuit board upon receiving a force, and the driven mechanism is pushed downwards to press and set on a circuit switch on the circuit board to generate a corresponding control signal. In the event that the keycap does not receive the force to move towards the circuit board, the driven mechanism provides a return elastic force to keep the keycap away from the circuit board at a selected elevation. While the aforesaid keyboard structure can achieve the object of command input, the driven mechanism is formed at a certain height that makes the keyboard have a certain thickness. In view of the present computer design requirement, lighter in weight and thinner in thickness is the main focus, especially for notebook computers. The thickness of keyboard module in the total thickness is the greatest factor affecting the thickness of the notebook computer. Hence almost all producers are endeavoring to design thinner keyboard to reduce total thickness.

In order to overcome the aforesaid problem, some producers have proposed other keyboard designs. For instance, TW patent No. M434979 discloses a design with a first support member and a second support member coupled to form a V-shaped structure to overcome the thickness problem caused by the conventional driven mechanism that adopts an X-shaped structure. Moreover, TW patent No. M426075 proposes a first support member and a second support member around the keycap to replace the conventional driven mechanism to reduce total thickness of the keyboard. Although they can reduce the keyboard thickness, they eventually implement the driven mechanism in other forms, and still require assembly of the driven mechanism and get a certain height. Namely, while the aforesaid techniques can make the keyboard thinner, they do not provide much improvement on the problem of complicated assembly.

### SUMMARY OF THE INVENTION

The primary object of the present invention is to provide improvement on the thickness problem of the conventional keyboards.

To achieve the foregoing object, the invention provides a keycap module fabricated by integrated injection. The keycap module includes a support frame which has a plurality of interlaced rims to define a plurality of keycap installation apertures. Each keycap installation aperture holds a keycap which has four sides and four corners. Each side of the keycap and each rim of the support frame have respectively a first wall and a second wall bridged by a movable arm. The keycaps, movable arms of the keycaps and rims of the support frame are integrally formed by injection. Each movable arm has a first connecting section connected to one corner of the keycap and a second connecting section connected to the first connecting section at a first bend spot. The second connecting section is extended towards a neighboring corner of the keycap and connected to one rim of the support frame.

In one embodiment each movable arm is formed at a thickness smaller than or equal to the thickness of each rim.

In another embodiment each movable arm is formed at a thickness smaller than or equal to the thickness of each keycap.

In yet another embodiment the second connecting section is parallel with one rim of the support frame and one side of the keycap.

In yet another embodiment one rim of the support frame is parallel with one side of the keycap, and the second connecting section is inclined at an angle against one rim of the support frame and one side of the keycap.

In yet another embodiment the first connecting section is connected to the first wall at a location at an elevation same as that of another location where the second connecting section is connected to the second wall, and the second connecting section, the keycap and the rims are at a same plane.

In yet another embodiment the first connecting section is connected to the first wall at a location at an elevation different from that of another location where the second connecting section is connected to the second wall, and the second connecting section forms an inclined angle against one side of the keycap and one rim of the support frame.

Aside from the aforesaid embodiment, the invention also provides another embodiment of keycap module which includes a support frame with a plurality of interlaced rims to define a plurality of keycap installation apertures. Each keycap installation aperture holds a keycap which has four sides and four corners. Each side of the keycap and each rim of the support frame have respectively a first wall and a second wall bridged by a movable arm. The keycaps, movable arms of the keycaps and rims of the support frame are integrally formed by injection. Each movable arm has a first connecting section connected to one corner of the keycap, a second connecting section connected to one rim of the support frame, and an extending section to bridge the first and second connecting sections. The extending section is connected to the first connecting section at a first bend spot and extended towards a neighboring corner of the keycap to connect to the second connecting section at a second bend spot, so that the extending section is connected to one rim of the support frame via the second connecting section.

In one embodiment each movable arm is formed at a thickness smaller than or equal to the thickness of each rim.

In another embodiment each movable arm is formed at a thickness smaller than or equal to the thickness of each keycap.

In yet another embodiment the extending section is parallel with one rim of the support frame and one side of the keycap.

In yet another embodiment one rim of the support frame is parallel with one side of the keycap, and the extending section is inclined at an angle against one rim of the support frame and one side of the keycap.

In yet another embodiment the first connecting section is formed at a length smaller than that of the second connecting section.

In yet another embodiment the first connecting section is formed at a length greater than that of the second connecting section.

In yet another embodiment the first connecting section is connected to the first wall at a location at an elevation same as that of another location where the second connecting section is connected to the second wall, and the extending section, the keycap and the rims are at a same plane.

In yet another embodiment the first connecting section is connected to the first wall at a location at an elevation different from that of another location where the second connecting section is connected to the second wall, and the extending section forms an inclined angle against one side of the keycap and one rim of the support frame.

The keycap module fabricated by integrated injection of the invention, compared with the conventional keyboards, provides features as follows:

1. The keyboard can be made thinner. In the invention, each keycap is supported by the movable arms so that it can be suspended from the circuit board at a distance. The movable arms also provide a return force for the pressed keycap to replace the conventional driven mechanism, thus overcomes the constraint of keyboard thickness caused by the height of the driven mechanism that makes lighter and thinner keyboards unattainable.

2. Simplified assembly. The invention, by omitting the complicated latching process involved with the driven mechanism, makes assembly of the keyboard much simpler.

The foregoing, as well as additional objects, features and advantages of the invention will be more readily apparent from the following detailed description, which proceeds with reference to the accompanying drawings.

### BRIEF DESCRIPTION OF THE DRAWINGS

FIG. 1 is a top view of the support frame of a first embodiment of the keycap module of the invention.

FIG. 2 is an exploded view of the first embodiment of the keycap module of the invention.

FIG. 3 is a cross section of the first embodiment of the keycap module of the invention.

FIG. 4 is a top view of the support frame of a second embodiment of the keycap module of the invention.

FIG. 5 is a top view of the support frame of a third embodiment of the keycap module of the invention.

FIG. 6 is a cross section of a fourth embodiment of the keycap module of the invention.

FIG. 7 is a top view of the support frame of a fifth embodiment of the keycap module of the invention.

FIG. 8 is a cross section of the fifth embodiment of the keycap module of the invention.

FIG. 9 is a top view of the support frame of a sixth embodiment of the keycap module of the invention.

FIG. 10 is a top view of the support frame of a seventh embodiment of the keycap module of the invention.

FIG. 11 is a cross section of an eighth embodiment of the keycap module of the invention.

### DETAILED DESCRIPTION OF THE PREFERRED EMBODIMENTS

The present invention aims to provide a keycap module fabricated by integrated injection. The keycap module is adaptable to many types of keyboards, such as those disclosed in U.S. Pat. Nos. 7,154,059, 7,628,500, 7,504,596, 8,184,021 and 8,292,444. The present invention takes a single illuminated keyboard as an example for discussion.

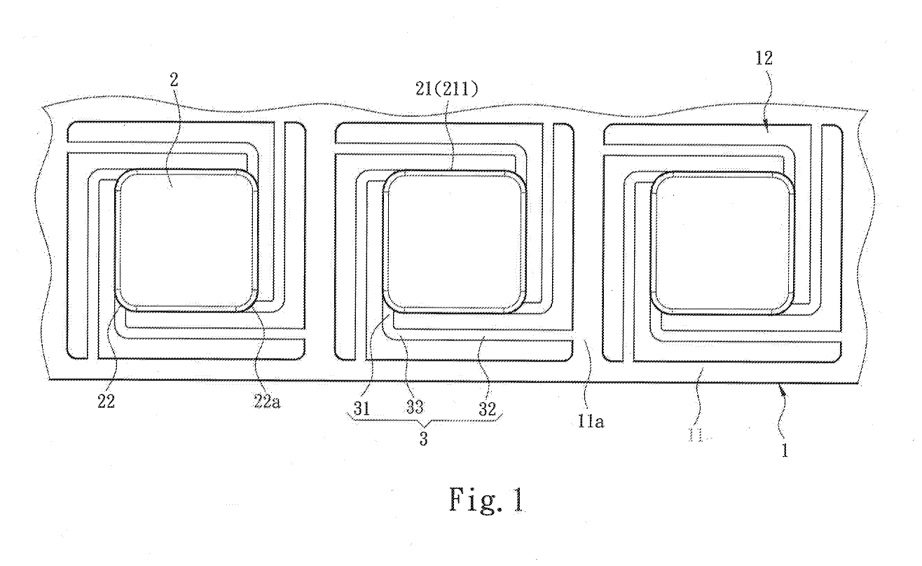

Please refer to FIGS. 1, 2 and 3, the keycap module according to the invention includes a support frame 1 which has a plurality of interlaced rims 11 to define a plurality of keycap installation apertures 12 on the support frame 1. Each keycap installation aperture 12 holds a keycap 2 which has four sides 21 and four corners 22. Each side 21 and each rim 11 have respectively a first wall 211 and a second wall 111 that are bridged by a movable arm 3. The support frame 1, keycaps 2 and movable arms 3 are integrally formed by injection. Namely, when the keycap module is formed by an injection process, the support frame 1, keycaps 2 and movable arms 3 are formed in the mold at the same time. More specifically, each movable arm 3 has a first connecting section 31 connected to one corner of the keycap 2 and a second connecting section 32 connected to the first connecting section 31 at a first bend spot 33. The second connecting section 32 is extended towards a neighboring corner 22a of the keycap 2 and connected to one rim 11a of the support frame 1.

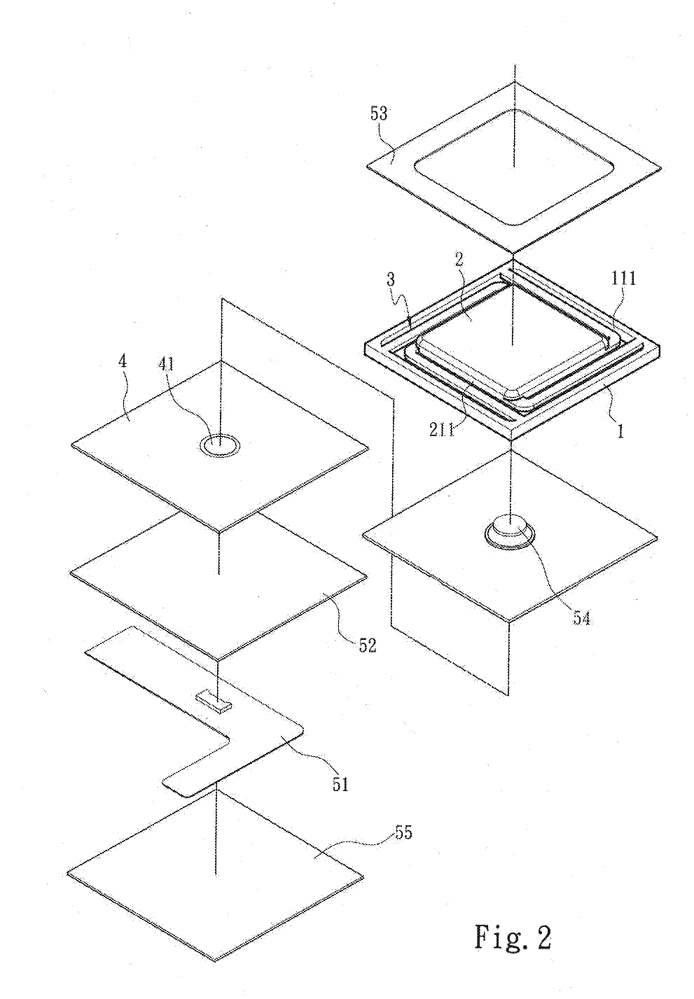

During assembly of the keycap module, the support frame 1 is overlapped above a circuit board 4 which contains a plurality of command trigger portions 41 each of which is corresponding to one keycap installation aperture 12. When the keycap 2 does not receive a force in normal conditions, it is suspended in the keycap installation aperture 12. When the keycap 2 receives the force and presses the command trigger portion 41 in a trigger movement, the second connecting section 32 of the movable arm 3 is driven by the keycap 2 to generate deformation, thereby the keycap 2 contacts the command trigger portion 41 to output a keyboard signal. When the external force is absent, the second connecting section 32 causes the keycap 2 to return to the normal conditions without receiving the force, and the keycap 2 is suspended again in the keycap installation aperture 12. As mentioned above, the keycap module is adaptable to various types of keyboards. FIG. 2 illustrates one type of the keyboards that includes a lighting source 51, a light guide plate 52, an optical mask 53, a plurality of buffer support members 54 and a keyboard baseboard 55.

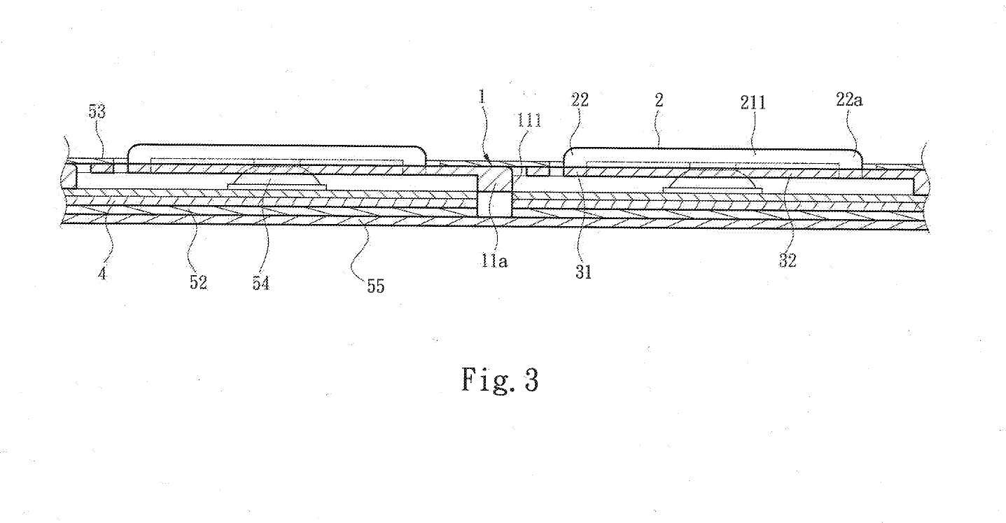

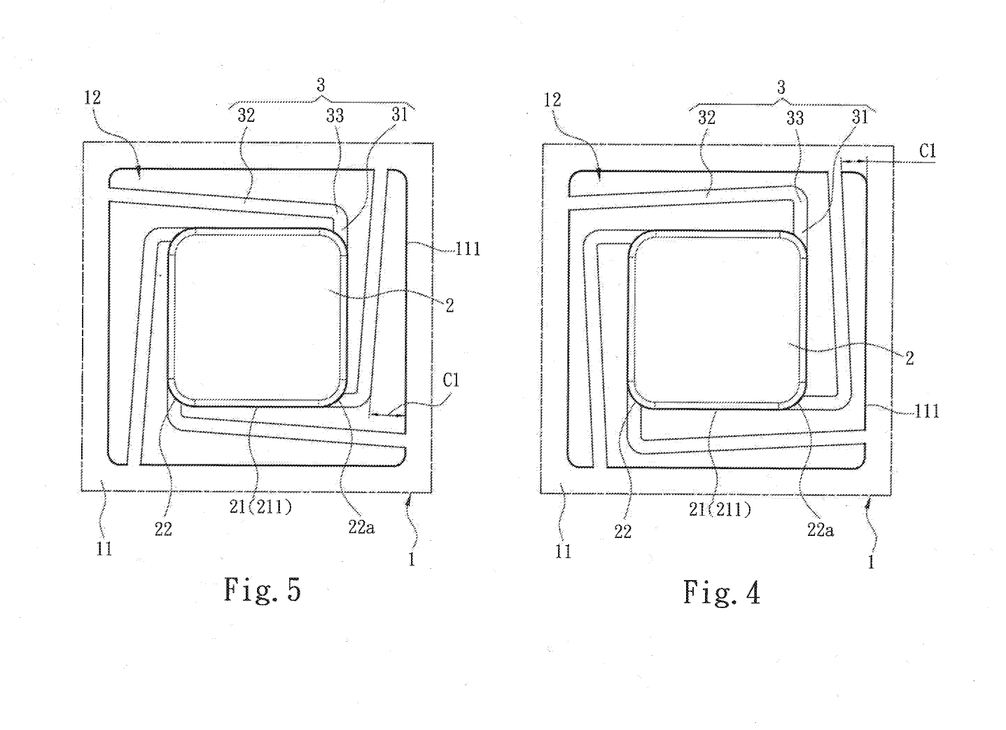

Furthermore, in response to different press feeling caused by different material, the keycap module of the invention can be adjusted partially, such as the thickness of the movable arm 3 relative to the rim 11 or keycap 2. For instance, the movable arm 3 can be formed at a thickness smaller than or equal to the thickness of the rim 11 or keycap 2, FIG. 3 illustrates an embodiment in which the thickness of the movable arm 3 is smaller than that of the rim 11 and keycap 2. Referring again to FIG. 1, one rim 11 is parallel with one side 21 of the keycap 2, and the second connecting section 32 of the movable arm 3 is extended between the first wall 211 and second wall 111. The second connecting section 32 can further be parallel with the first wall 211 and second wall 111, i.e., the second connecting section 32 is parallel with the rim 11 and one side 21 of the keycap 2. Aside from the parallel embodiment previously discussed, the second connecting section 32 can also be extended between the first wall 211 and second wall ill and inclined at an angle C1 against one rim 11 and one side 21 of the keycap 2 as shown in FIGS. 4 and 5.

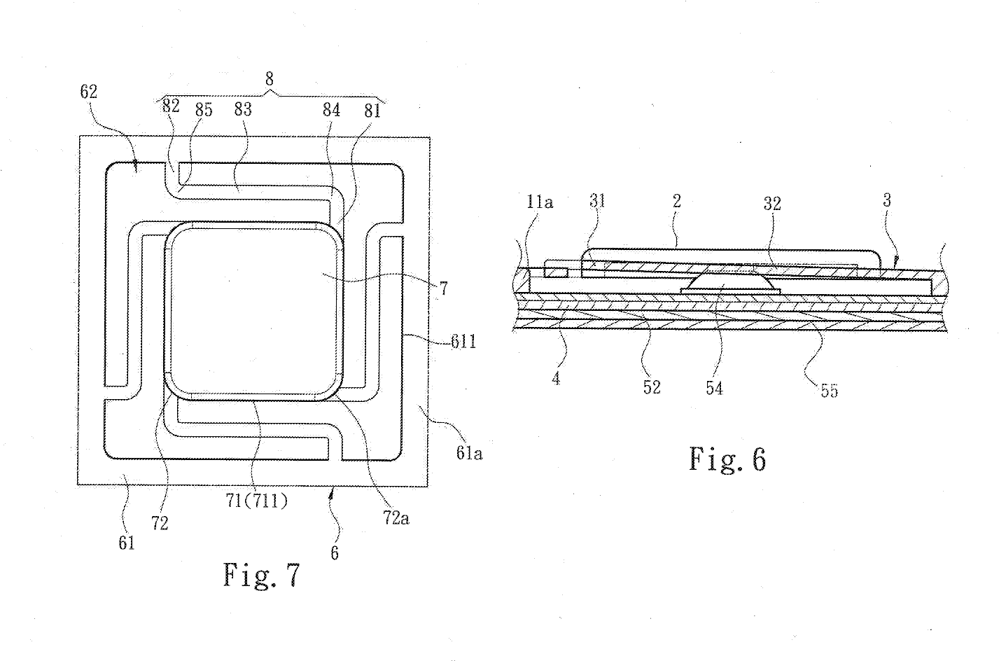

Please refer to FIG. 1 again, after the keycap module is integrally formed by injection, the locations where the first connecting section 31 connected to the first wall 211 and where the second connecting section 32 connected to the second wall 111 can be at the same elevation so that the movable arms 3, keycap 2 and rims 11 are at the same plane. In addition to the embodiment previously discussed, referring to FIG. 6, the locations where the first connecting section 31 connected to the first wall 211 and where the second connecting section 32 connected to the second wall 111 can also be at different elevations so that the second connecting section 32 forms an inclined angle C2 against the keycap 2 and the rims 11.

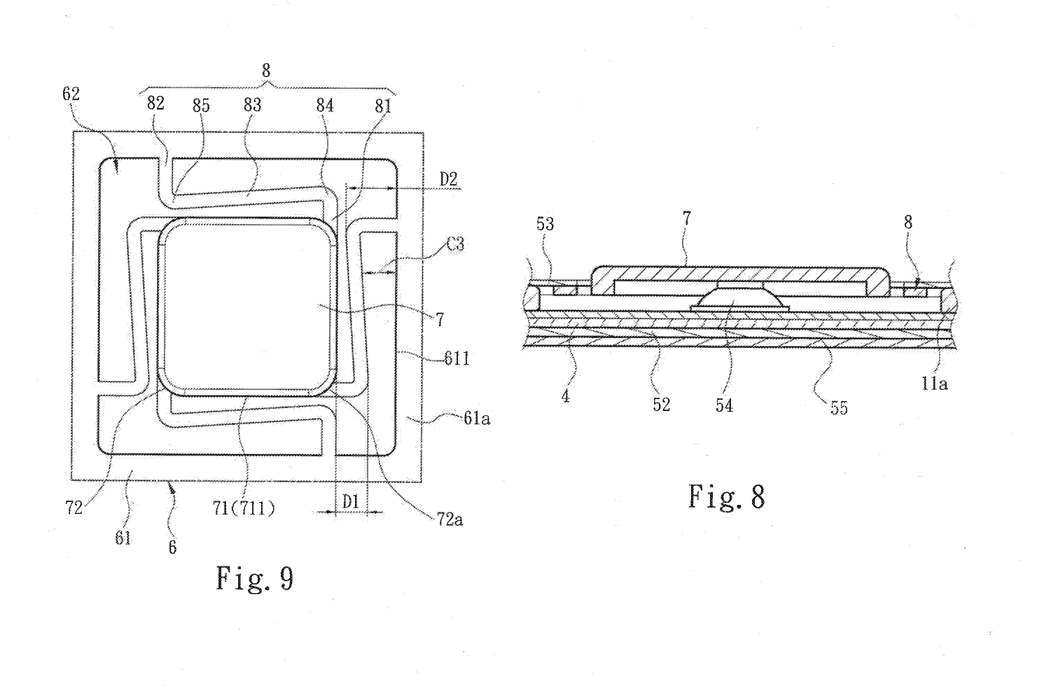

On the other hand, the keycap module of the invention can further be formed in yet another embodiment. Please refer to FIGS. 7 and 8, in this embodiment, the keycap module includes a support frame 6 which has a plurality of interlaced rims 61 to define a plurality of keycap installation apertures 62. Each keycap installation aperture 62 holds a keycap 7 which has four sides 71 and four corners 72. Each side 71 and each rim 61 have respectively a first wall 711 and a second wall 611 that are bridged by a movable arm 8. The movable arms 8, keycaps 7 and rims 61 are integrally formed by injection. Namely, when the keycap module is formed by an injection process, the support frame 6, keycaps 7 and movable arms 8 are formed in the mold. Furthermore, each movable arm 8 has a first connecting section 81 connected to one corner 72 of the keycap 7, a second connecting section 82 connected to one rim 61 of the support frame 6, and an extending section 83 to bridge the first connecting section 81 and second connecting section 82. The extending section 83 is connected to the first connecting section 81 at a first bend spot 84 and extended towards a neighboring corner 72a of the keycap 7 to connect to the second connecting section 82 at a second bend spot 85, so that the extending section 83 is connected to the rim 61 of the support frame 6 via the second connecting section 82.

The movable arm 8 supports the keycap 7 to suspend in the keycap installation aperture 62 in the normal conditions. When the keycap 7 receives an external force to proceed a trigger movement, the extending section 83 of the movable arm 8 generates deformation. When the external force is absent, the keycap 7 is driven to return to the original position in the normal conditions.

Furthermore, in response to different press feeling caused by different material, the keycap module of this embodiment can also be adjusted partially, such as the thickness of the movable arm 8 relative to the rim 61 or keycap 7. For instance, the movable arm 8 can be formed at a thickness smaller than or equal to the thickness of the rim 61 or keycap 7 as shown in FIG. 8.

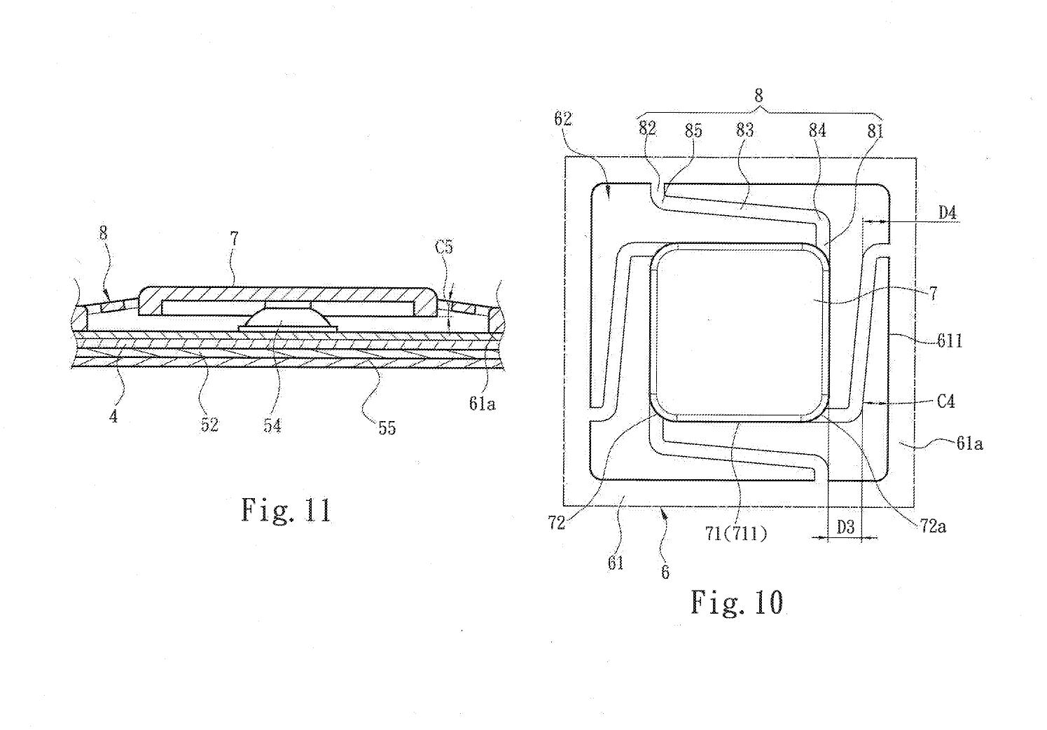

Also referring to FIG. 7 again, in this embodiment, one rim 61 is parallel with one side 71 of the keycap 7, and the extending section 83 of the movable arm 8 is extended between the first wall 711 and second wall 611, and also is parallel therewith, i.e., the extending section 83 is parallel with the rim 61 and one side 71 of the keycap 7. Moreover, asides from the parallel embodiment previously discussed, the extending section 83 also can be extended between the first wall 711 and second wall 611 and inclined at an angle C3 against the rim 61 and one side 71 of the keycap 7 as shown in FIG. 9. In addition, in yet another embodiment, the first connecting section 81 of the movable arm 8 can be formed at a length D1 smaller than the length D2 of the second connecting section 82 so that the extending section 83 is inclined at the angle C3. Please refer to FIG. 10, in addition to the embodiment previously discussed, the first connecting section 81 also can be formed at a length D3 greater than the length D4 of the second connecting section 82, and the extending section 83 is extended between the first wall 711 and second wall 611 and inclined at another angle C4.

Moreover, in this embodiment, after the keycap module is integrally formed by injection, the locations where the first connecting section 81 connected to the first wall. 711 and where the second connecting section 82 connected to the second wall 611 can be at a same elevation, i.e., the extending section 83 is extended horizontally between the first wall 711 and second wall 611 so that the extending section 83, the keycap 7 and the rims 61 are at the same plane as shown in FIG. 8. On the other hand, referring to FIG. 11, the locations where the first connecting section 81 connected to the first wall 711 and where the extending section 83 connected to the second wall 611 can also be at different elevations so that the extending section 83 forms another inclined angle C5 against the keycap 7 and the rim 61.

As a conclusion, the keycap module fabricated by integrated injection according to the invention has a support frame with a plurality of interlaced rims to define a plurality of keycap installation apertures. Each keycap installation aperture holds a keycap which has four sides and four corners. Each side and each rim have respectively a first wall and a second wall bridged by a movable arm. The keycaps, movable arms and support frame are integrally formed by injection. Each movable arm has a first connecting section connected to one corner of the keycap and a second connecting section connected to the first connecting section at a first bend spot, and the second connecting section is extended towards a neighboring corner of the keycap and connected to one rim of the support frame. With each keycap supported by the movable arms, it can be moved against a circuit board in a trigger movement to trigger the circuit board to output a keyboard signal. The structure of the invention thus formed provides significant improvement to overcome the constraint of the driven mechanism of the conventional keyboards that makes thinner keyboards unattainable.

What is claimed is:

1. A keycap module fabricated by integrated injection, comprising:
a support frame including a plurality of interlaced rims that define a plurality of keycap installation apertures; and
a plurality of keycaps corresponding to the keycap installation apertures to be held therein, each of the plurality of keycaps including four sides and four corners, each side of the keycap and each rim of the support frame including respectively a first wall and a second wall that are bridged by a moveable arm, the keycaps, the movable arms of the keycaps and the rims of the support frame being integrally formed by injection, the movable arm including a first connecting section connecting to one corner of the keycap and a second connecting section connecting to the first connecting section at a first bend spot and extending towards the neighboring corner of the keycap to connect to one rim of the support frame.

2. The keycap module of claim 1, wherein the movable arm is formed at a thickness smaller than or equal to that of the rim.

3. The keycap module of claim 1, wherein the movable arm is formed at a thickness smaller than or equal to that of the keycap.

4. The keycap module of claim 1, wherein the second connecting section is parallel with one rim of the support frame and one side of the keycap.

5. The keycap module of claim 1, wherein one rim of the support frame is parallel with one side of the keycap, and the Second connecting section is inclined at an angle against one rim of the support frame and one side of the keycap.

6. The keycap module of claim 1, wherein the first connecting section is connected to the first wall at a location at an elevation same as that of another location where the second connecting section is connected to the second wall, and the seconding connecting section, the keycap and the rims are at a same plane.

7. The keycap module of claim 1, wherein the first connecting section is connected to the first wall at a location at an elevation different from that of another location where the second connecting section is connected to the second wall, and the second connecting section forms an inclined angle against one side of the keycap and one rim of the support frame.

8. A keycap module fabricated by integrated injection, comprising:
a support frame including a plurality of interlaced rims that define a plurality of keycap installation apertures; and
a plurality of keycaps corresponding to the keycap installation apertures to be held therein, each of the plurality of keycaps including four sides and four corners, each side of the keycap and each rim of the support frame including respectively a first wall and a second wall that are bridged by a moveable arm, the keycaps, the movable arms of the keycaps and the rims of the support frame being integrally formed by injection, the movable arm including a first connecting section connecting to one corner of the keycap, a second connecting section connecting to one rim of the support frame, and an extending section to bridge the first connecting section and the second connecting section, the extending section connecting to the first connecting section at a first bend spot and extending towards the neighboring corner of the keycap to connect to the second connecting section at a second bend spot so that the extending section is connected to one rim of the support frame through the second connecting section.

9. The keycap module of claim 8, wherein the movable arm is formed at a thickness smaller than or equal to that of the rim.

10. The keycap module of claim 8, wherein the movable arm is formed at a thickness smaller than or equal to that of the keycap.

11. The keycap module of claim 8, wherein the extending section is parallel with one rim of the support frame and one side of the keycap.

12. The keycap module of claim 8, wherein one rim of the support frame is parallel with one side of the keycap, and the extending section is inclined at an angle against one rim the support frame and one side of the keycap.

13. The keycap module of claim 12, wherein the first connecting section is formed at a length smaller than that of the second connecting section.

14. The keycap module of claim 12, wherein the first connecting section is formed at a length greater than that of the second connecting section.

15. The keycap module of claim 8, wherein the first connecting section is connected to the first wall at a location at an elevation same as that of another location where the second connecting section is connected to the second wall, and the extending section, the keycap and the rims are at a same plane.

16. The keycap module of claim 8, wherein the first connecting section is connected to the first wall at a location at an elevation different from that of another location where the second connecting section is connected to the second wall, and the extending section forms an inclined angle against one side of the keycap and one rim of the support frame.
